(19) United States
(12) Patent Application Publication
(10) Pub. No.: US 2025/0278119 A1
(43) Pub. Date: Sep. 4, 2025

(54) DISPLAY PANEL AND ELECTRONIC DEVICE

(71) Applicant: Lenovo (Beijing) Limited, Beijing (CN)

(72) Inventors: Wenzhang WANG, Beijing (CN); Zhengliu LU, Beijing (CN); Jingjing YU, Beijing (CN); Shaopeng PENG, Beijing (CN)

(21) Appl. No.: 19/059,229

(22) Filed: Feb. 20, 2025

(30) Foreign Application Priority Data
Feb. 29, 2024 (CN) 202410232696.4

(51) Int. Cl. G06F 1/16

(52) U.S. Cl. CPC G06F 1/1652; G06F 1/1681

(57) ABSTRACT

A display panel includes a flexible display screen and a support plate. The flexible display screen includes a flexible section and switches between at least a flat state and a deformed state through the flexible section. The support plate is located on a non-display output side of the display screen and includes a target section corresponding to the flexible section of the display screen. The target section includes a first area and a second area arranged along a first direction. The first area includes a first through-hole arranged along a second direction. The second area includes a second through-hole arranged along the second direction. the first through-hole and the second through-hole have different sizes. The second direction is different from the first direction.

### CROSS-REFERENCE TO RELATED APPLICATION

The present disclosure claims priority to Chinese Patent Application No. 202410232696.4, filed on Feb. 29, 2024, the entire content of which is incorporated herein by reference.

### TECHNICAL FIELD

The present disclosure is related to the electronic technology field and, more particularly, to a display panel and an electronic device including the display panel.

### BACKGROUND

With the development of display technology, flexible display screens are widely applied and have been used in display panels of various electronic devices. In various applications, a flexible display screen needs to be bonded with a support assembly to form a display panel. Thus, the support assembly can be configured to support the form of the flexible display screen so that the flexible display screen can maintain its form. However, the reliability of the current electronic device with a flexible display needs to be improved.

### SUMMARY

An aspect of the present disclosure provides a display panel including a flexible display screen and a support plate. The flexible display screen includes a flexible section and switches between at least a flat state and a deformed state through the flexible section. The support plate is located on a non-display output side of the display screen and includes a target section corresponding to the flexible section of the display screen. The target section includes a first area and a second area arranged along a first direction. The first area includes a first through-hole arranged along a second direction. The second area includes a second through-hole arranged along the second direction. The first through-hole and the second through-hole have different sizes. The second direction is different from the first direction.

An aspect of the present disclosure provides an electronic device, including a display panel and a connection apparatus. The display panel includes a flexible display screen and a support plate located on a non-display output side of the display screen. The display screen includes a flexible section. The support plate includes a target section corresponding to the flexible section of the display screen. The connection apparatus corresponds to the target section. The electronic device performs device form change through the connection apparatus, and the flexible section and the target section change form. The target section includes a first area and a second area arranged in the first direction. The first area includes a first through-hole arranged along the second direction. The second area includes the second through-hole arranged along the second direction. The first through-hole and the second through-hole have different sizes. The second direction is different from the first section.

An aspect of the present disclosure provides an electronic device, including a display panel and a connection apparatus. The display panel includes a flexible display screen and a support plate located on a non-display output side of the display screen. The display screen includes a flexible section. The support plate includes a target section corresponding to the flexible section of the display screen. The connection apparatus corresponds to the target section. The electronic device performs device form change through the connection apparatus. The flexible section and the target section change form with. The target section includes a first area and a second area arranged in the first direction. The first area includes a first through-hole arranged along the second direction, and the second area includes the second through-hole arranged along the second direction. The first through-hole and the second through-hole have different sizes. The second direction is different from the first section.

### BRIEF DESCRIPTION OF THE DRAWINGS

FIG. 1 illustrates a schematic diagram of a display panel in an expanded state according to some embodiments of the present disclosure.

FIG. 2 illustrates a schematic diagram showing a form of a support plate when a display panel is in a folded state according to some embodiments of the present disclosure.

FIG. 3 illustrates a schematic front view diagram of a support plate of a display panel according to some embodiments of the present disclosure.

FIG. 4 illustrates a schematic enlarged diagram of area 201 in FIG. 3.

FIG. 5 illustrates a schematic enlarged diagram of area A in FIG. 4.

FIG. 6 illustrates a schematic left view diagram of a support plate of a display panel according to some embodiments of the present disclosure.

FIG. 7 illustrates a schematic enlarged diagram of area C in FIG. 6.

FIG. 8 illustrates a schematic enlarged diagram of area A in another display panel according to some embodiments of the present disclosure.

FIG. 9 illustrates a schematic diagram showing a local form of a support plate when a display panel is in a folded state according to some embodiments of the present disclosure.

FIG. 10 illustrates a schematic diagram showing a relative position of two neighboring rows of through-holes of another display panel according to some embodiments of the present disclosure.

FIG. 11 illustrates a schematic enlarged diagram of area A in another display panel according to some embodiments of the present disclosure.

FIG. 12 illustrates a schematic enlarged diagram of area A in another display panel according to some embodiments of the present disclosure.

FIG. 13 illustrates a schematic structural diagram of an electronic device according to some embodiments of the present disclosure.

FIG. 14 illustrates a schematic local structural diagram of an electronic device in a bent state according to some embodiments of the present disclosure.

FIG. 15 illustrates a schematic local structural diagram of an electronic device in an accommodated state according to some embodiments of the present disclosure.

FIG. 16 illustrates a schematic local structural diagram of an electronic device in a flat state according to some embodiments of the present disclosure.

### DETAILED DESCRIPTION OF THE EMBODIMENTS

Embodiments of the present disclosure are described in detail below in conjunction with the accompanying drawings of embodiments of the present disclosure. Obviously, the embodiments described are only some embodiments of the present disclosure, not all embodiments. Based on embodiments of the present disclosure, all other embodiments obtained by those skilled in the art without creative efforts shall fall within the scope of the present disclosure.

Without departing from the spirit or scope of the present disclosure, various modifications and changes can be made within the present disclosure, which are apparent to those skilled in the art. Therefore, the present disclosure is intended to cover modifications and changes of the present disclosure that fall within the scope of the corresponding claims (the technical solutions requiring protection) and their equivalents. Embodiments of the present disclosure can be combined with each other as long as there is no contradiction.

To make the above purposes, features, and advantages of the present disclosure more comprehensible, the present disclosure is further described in detail in connection with accompanying drawings and specific embodiments.

As described in the background section, the reliability of an electronic device with a flexible display screen needs to be improved.

In some embodiments, a support assembly in a display panel of the electronic device configured to support the flexible display screen can include a support plate. The support plate plays a decisive role in supporting the flexible display screen. Currently, in applications, the support plate can be primarily made of materials such as SUS (stainless steel), titanium alloy, or carbon fiber board with a certain thickness (e.g., about 150 m). However, regardless of the material used, to meet the requirement of foldability of the electronic device, the support plate needs to be patterned to enhance bending performance of the support plate to improve the bending performance of the electronic device. In the electronic device, the support plate is a direct carrier for connecting the display panel to the whole device of the electronic device. The display panel can be glued to the housing in a PSA (pressure swing adsorption) or LDA (temperature swing adsorption) process to achieve the assembly of the display panel at the whole device.

Additionally, when the electronic device hits or drops, the housing of the electronic device can be a direct recipient of the impact. After the electronic device drops, the impact on the housing of the electronic device can further propagate throughout the entire system. The support plate can be the first recipient of the impact within the display panel. Therefore, when the structural strength of the support plate is, the impact force received by the support plate is greater, and the impact propagates into the display screen can be reduced. Thus, the probability of damaging the display screen can be small, the risk in the reliability of the whole device of the display panel can be lower, and the reliability of the electronic device when dropping can be stronger.

For the same position on the support plate, when the structural strength at the position is increased, the bending performance at the position can be lowered. On the contrary, when the bending performance at the position is increased, the structural strength at the position can be lowered. Thus, it is technically challenging to balance the bending performance and structural strength of the support plate.

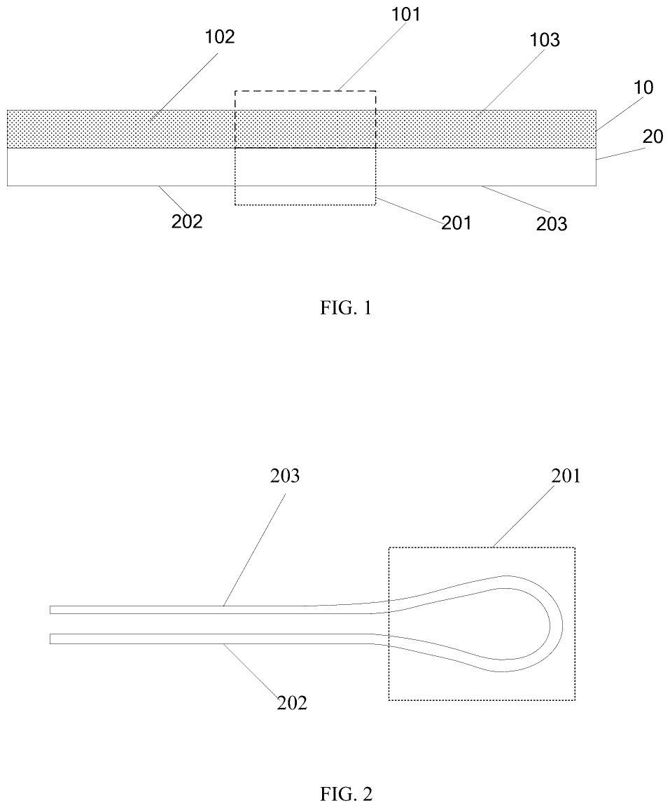

Based on this, embodiments of the present disclosure provide a display panel. As shown in FIG. 1, the display panel includes a flexible display screen 10 and a support plate 20.

The display screen 10 includes a flexible section 101. The display screen 10 can switch at least between a flat state (as shown in FIG. 1) and a deformed state (as shown in FIG. 2) through the flexible section 101. In some embodiments, the deformed state can include folded states at various angles, such as a folded-in-half state or a 900 folded state, which is not limited and set as needed.

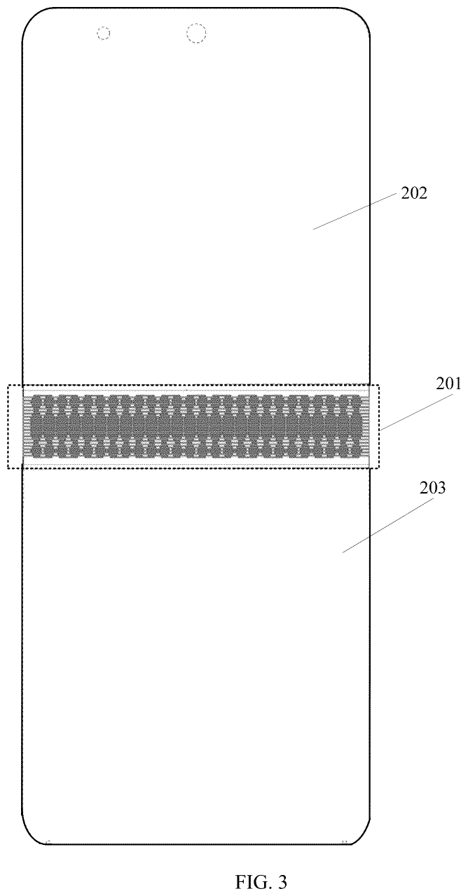

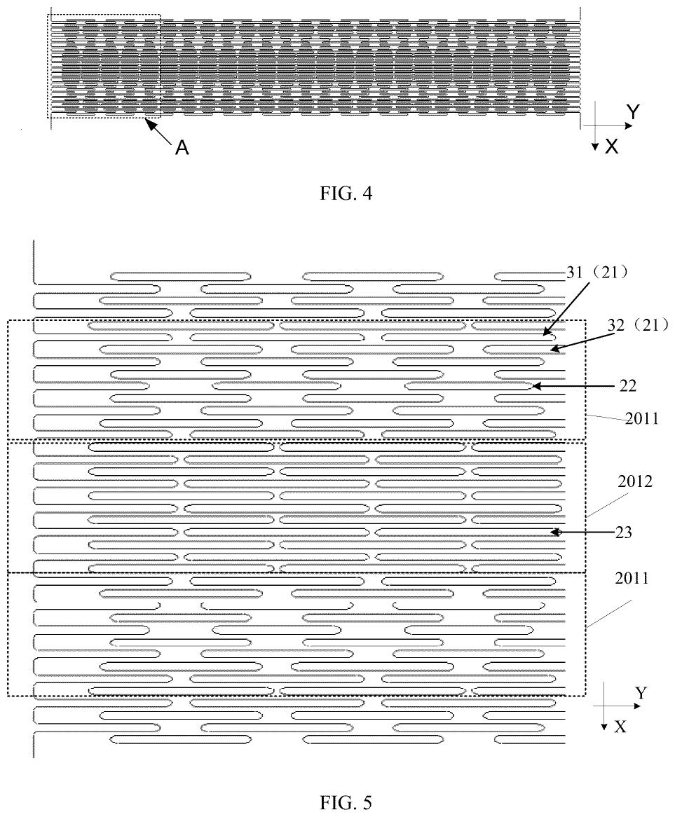

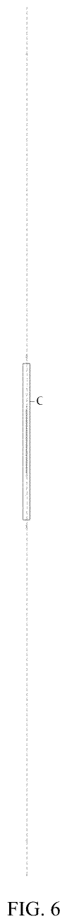

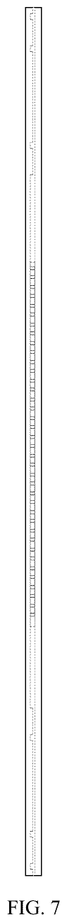

The support plate 20 is on a non-display output side of the display screen 10. The support plate 20 includes a target section 201 corresponding to the flexible section 101 of the display screen. As shown in FIGS. 3-7, FIG. 3 is a front view of the support plate. FIG. 4 is an enlarged view of area 201 in FIG. 3. FIG. 5 is an enlarged view of a dashed area A in FIG. 4. FIG. 6 is a left view of the support plate. FIG. 7 is an enlarged view of area C in FIG. 6. The target section 201 includes a first area and a second area arranged in a first direction X. The first area includes a first through-hole 31 arranged in a second direction Y. The second area includes a second through-hole 32 arranged in a second direction Y. The first through-hole 31 and the second through-hole 32 can have different sizes.

In embodiments of the present disclosure, the second direction can be different from the first direction. In some embodiments, when the display panel is folded in half parallel, the first direction is in parallel with a folding axis of the flexible section. The second direction can be perpendicular to the first direction, which is not limited here.

In embodiments of the present disclosure, as shown in FIGS. 1 to 3, the display screen further includes a first screen section 102 and a second screen section 103 located on opposite sides of the flexible section. The support plate 20 further includes a first support board 202 corresponding to the first screen section 102 and a second support board 203 corresponding to the second screen section 103. The flexible section can also be a display section, which is not limited here.

In embodiments of the present disclosure, the first support board and the second support board may need to provide support performance for the display screen. The target section not only needs to provide support performance for maintaining the form of the flexible section but also have bending performance to allow the flexible section to deform. In some embodiments, when the display panel is in a flat state, the support plate provides support corresponding to the display screen to ensure the display screen remains in the flat state. In some embodiments, the first support board can support the first screen section to allow the first screen section to be in the flat state, and the second support board can support the second screen section to allow the second target section to be in the flat state. The target section can support the flexible section to cause the flexible section to be partially in a flat state. When the display panel is in a deformed state, the support plate can support the display screen to ensure the display panel remains in the deformed state. In some embodiments, the first support board can support the first screen section to cause the first screen section to be in the flat state, and the second support board can support the second screen section to cause the second target section to be in the flat state. The target section can support the flexible section to cause the flexible section to be in the deformed state.

In some embodiments of the present disclosure, the first support board and the second support board in the support plate may not be provided with through-holes, and only the target section may be provided with through-holes, which is not limited here. In other embodiments of the present disclosure, the first support board and the second support board may also be partially provided with through-holes. For example, as shown in FIG. 5, the area close to the target section is provided with through-holes, which depends on actual needs.

In embodiments of the present disclosure, the first through-holes and the second through-holes in the target section of the support plate corresponding to the flexible section of the display screen can have different sizes in the second direction. By setting through-holes of different sizes in different areas of the support plate, the bending performance and structural strength of the support plate can be balanced. Thus, the structural strength of the support plate can be improved while ensuring the bending performance of the support plate to increase the impact force that the support plate can withstand, and reduce the impact on the display screen when the display panel drops. Thus, the probability of damaging the display panel can be reduced to balance the bending performance and the reliability of the display panel.

In embodiments of the present disclosure, the first area and the second area of the target section can be two neighboring areas in the first direction. That is, in the target section, the through-holes in the two neighboring areas can have different sizes in the second direction. In embodiments of the present disclosure, the first area and the second area can be certain or any two neighboring areas in the target section, which are not limited, as long as the through-holes of at least two neighboring areas in the target section have different sizes in the second direction.

As shown in FIG. 5, in embodiments of the present disclosure, the target section includes a first target section 2011 and a second target section 2012. The bending capability of the second target section 2012 can be greater than the bending capability of the first target section 2011. In some embodiments, the second target section 2012 can at least correspond to the central area of the flexible section of the display screen. That is, when the second target section 2012 at least corresponds to the bending central area of the display screen when the display panel is in the deformed state. The first target section 2011 can be an area in the target section neighboring to the second target section 2012. In embodiments of the present disclosure, in the first direction, the first target section 2011 can be on a side or two sides of the second target section 2012. One or more second target sections 2012 can be provided, which is not limited and set as needed.

The description is made by taking the following example. That is, the support plate can include a second target section 2012 and two first target section 2011. The two first target sections 2011 can be on two sides of the second target section 2012.

In some embodiments of the present disclosure, at least one area of the first area and the second area can be at the first target section. That is, at least one type of through-hole of the first through-hole and the second through-hole can be at the first target section. In embodiments of the present disclosure, one of the first area and the second area can be at the first target section, and the other one can be at the second target section. In some other embodiments, the first area and the second area can be at the first target section, which is not limited.

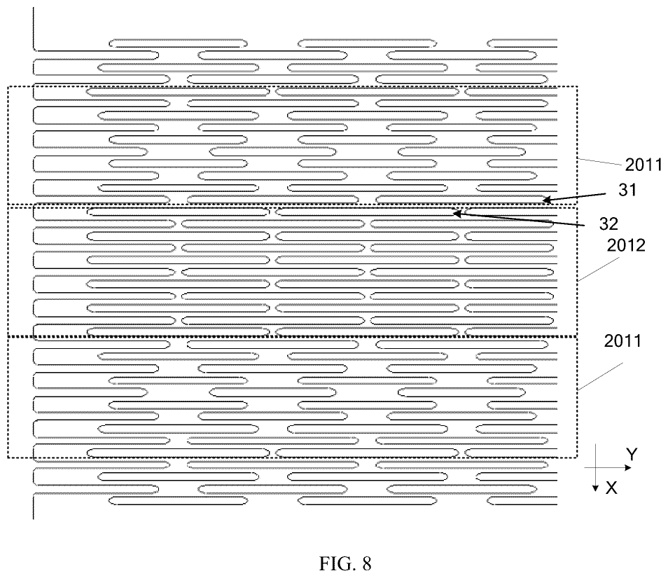

In some embodiments of the present disclosure, as shown in FIG. 8, the first area is at the first target section, and the second area is at the second target section. That is, the first through-hole 31 is at the first target section 2011, and the second through-hole 32 is at the second target section 2012. In some embodiments, the size of the first through-hole 31 in the second direction Y can be smaller than the size of the second through-hole 32 in the second direction. Then, the second through-hole 32, with a relatively large size in the second direction Y, can be arranged at the second target section 2012 to improve the bending performance of the section of the support plate corresponding to the bending central area of the display panel. The first through-hole 31, with a relatively small size in the second direction Y, can be arranged at the first target section 2011 to improve the structural strength of the first target section 2011 to improve the structural strength of the support plate. Thus, the maximum impact force that the support plate can withstand can be improved, and the reliability of the display panel can be improved.

In some other embodiments of the present disclosure, as shown in FIG. 5, the first area and the second area are at the first target section. That is, the first through-hole 31 and the second through-hole 32 are at the first target section 2011. By forming through-holes of different sizes at the first target section 2011 in the second direction Y, the bending performance and the structural strength of the first target section 2011 can be well balanced. In some embodiments, the first area and the second area can be any two neighboring areas of the first target section. The through-holes of different sizes in the second direction can be formed according to the requirements of different positions in the first target section to balance the bending performance and the structural strength of the first target section, which is not limited here.

As shown in FIG. 5, in some embodiments of the present disclosure, the first target section 2011 includes a plurality of first target through-holes 21 arranged in the first direction X. The first through-hole 31 and the second through-hole 32 can be the first target through-holes of different rows in a plurality of rows of first target through-holes, e.g., neighboring first target through-holes or first target through-holes of different rows.

When the flexible section of the display screen is in a deformed state, the size and type of stress experienced by different areas of the target section can be different. Correspondingly, when the display panel is subjected to impact, the maximum impact forces that different areas of the target section can withstand can also be different. In some embodiments of the present disclosure, the first target section can include the plurality of rows of first target through-holes arranged along the first direction. Among the plurality of rows of first target through-holes, the first target through-holes 22 of the target row can have the smallest size in the second direction Y. Thus, in the target section, the position where the first target through-holes 22 of the target row are located can have the maximal structural strength and can withstand the maximum impact force. Thus, by forming the through-holes with the smallest size in the area of the support plate corresponding to the position of the display panel withstanding the least risk, the structural strength of the area of the support plate corresponding to the position of the display panel withstanding the least risk can be improved as much as possible while the bending performance of the target section is ensured. Thus, the risk resistance of the area of the support plate corresponding to the position of the display panel withstanding the least risk can be improved to improve the reliability of the display panel.

In some embodiments of the present disclosure, the display panel can be an OLED display panel. The display screen can include an array substrate, a light-emitting layer formed on the surface of the array substrate, and an encapsulation layer encapsulating the light-emitting layer. The array substrate can further include a plurality of composition layers. When the display panel is in a deformed state, the stress distribution on different composition layers of the display screen can be different. Correspondingly, the points with the highest risk can be different.

In the display screen, the encapsulation layer can be the most fragile section in the display panel. When the display panel is dropped, the encapsulation layer can be the most likely to fail. In some embodiments of the present disclosure, taking the encapsulation layer as an inspection object, the position of the display screen with the highest risk can be determined to determine the positions of the first target through-holes of the target row in the support plate, which is not limited. In some other embodiments, the inspection object can also include any other composition layers in the display screen, which is set as needed. By taking the inspection object being the encapsulation layer as an example, the display panel of embodiments of the present disclosure can be described.

Since the material of the encapsulation layer is primarily tetrafluoroethylene (TFE), the compressive strength and tensile strength of the encapsulation layer can be different. Therefore, in embodiments of the present disclosure, when the display panel is dropped, the impact on the display panel can propagate at the bending section (i.e., corresponding to the flexible section and the target section) of the display panel in a wave with alternating peaks and troughs. The encapsulation layer can withstand a relatively large compressive stress and relatively small tensile stress. Under the alternating stresses, the encapsulation layer can most likely fail. That is, the point of the encapsulation layer with the different types of stresses (or strains) alternating can withstand the lowest risk. Therefore, when the support plate is impacted, the point of the encapsulation layer with the different types of stresses (or strains) alternating has the highest reliability risk. Correspondingly, the display screen can have the highest reliability risk.

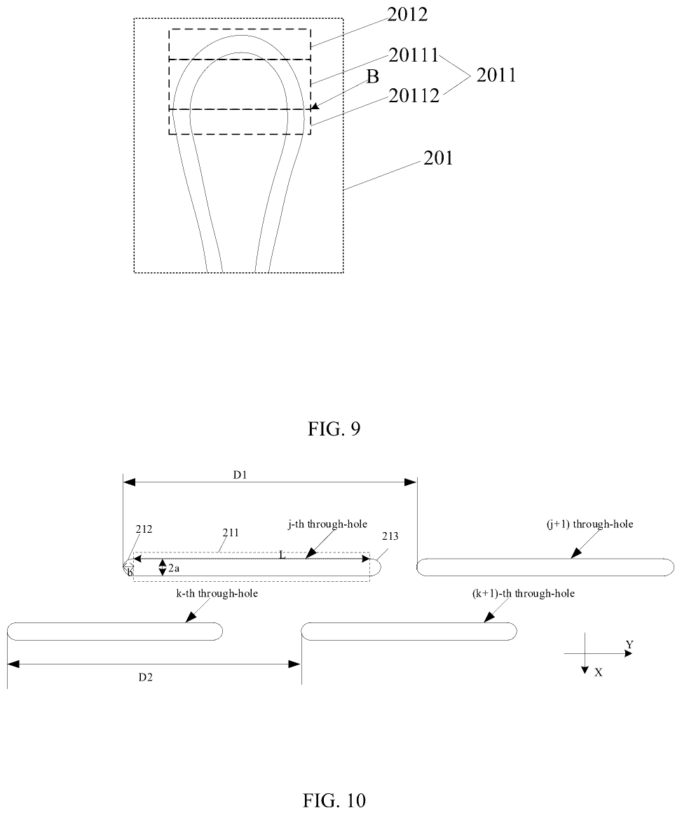

For example, as shown in FIG. 9, the display panel is folded in half. The first target section 2011 includes a first deformation area 20111 and a second deformation area 20112. When the display panel is dropped, and after the encapsulation layer is subjected to impact, the strain types of a portion of the encapsulation layer corresponding to the first deformation area 20111 and the second deformation area 20112 can be different, e.g., one may be a compressive strain, while the other one may be a tensile strain. At the boundary position B between the first deformation area 20111 and the second deformation area 20112, i.e., the boundary point of different types of strains in the encapsulation layer, the encapsulation layer can withstand the lowest risk. That is, when the support plate is subjected to the impact, the portion of the encapsulation layer corresponding to the boundary position B of the first deformation area 20111 and the second deformation area 20112 can have the highest reliability risk.

Therefore, in embodiments of the present disclosure, the position of the first target through-hole in the target row of the target section can correspond to the boundary position between the first deformation area and the second deformation area. That is, the first target through-hole 22 of the target row in FIG. 8 is at the boundary position B of the first deformation area and the second deformation area, which is not limited.

In the first direction, in the plurality of rows of first target through-holes, as the distances to the first target through-holes of the target row increase, the position of the first target through-holes can withstand higher risk. Thus, in some embodiments of the present disclosure, when the distance of the first target through-hole at a far end of the first target section to the first target through-hole of the target row is further in the first direction, the size of the first target through-hole can be larger. Then, the through-holes with different sizes can be formed at positions of the first target section that withstand different impact risks. Thus, different positions in the target section can have a good balance in the bending performance and the structural strength to improve the impact resistance capability of the target section of the support plate by ensuring the bending performance of the target section of the support plate. Thus, the bending performance and the reliability of the display panel can be well balanced.

In some embodiments of the present disclosure, when the display panel is in a flat state, as shown in FIG. 10, the first target through-hole is an oval-shaped hole in the first direction. The first target through-hole includes a rectangular section 211 and a first curved section 212 and a second curved section 213 on opposite two sides of the rectangular section 211 in the second direction Y. In some embodiments, the first curved section 212 and the second curved section 213 are symmetrical about the center of the rectangular section 211. As further shown in FIG. 10, the size of the rectangular section 211 in the second direction Y is a first size L, and the size of the rectangular section 211 in the first direction X is a second size 2a. The distance between a top end of the first curved section 212 away from the rectangular section 211 and the rectangular section 211 can be a third size b. In the first direction, the first sizes of different first target through-holes can increase as the distances between the different first target through-holes and the first target through-holes of the target row increase. The second size can be the same as the third size.

In some embodiments, in the first target section, in a direction away from the first target through-hole of the target row, the first target section can include M rows of first target through-holes. The first size of the first target through-hole of the n-th row can be Ln=Lmin+h*n. Lmin denotes the first size of the first target through-hole of the target row, h denotes a predetermined number, and n ranges from 1 to M.

In some embodiments of the present disclosure, h=a+b, i.e., Ln=Lmin+(a+b)*n. Thus, the first sizes of the first target through-holes of the plurality of rows can uniformly increase in the direction away from the first target through-hole of the target row. Then, the structural strengths at different positions of the support plate can uniformly change. Thus, the structural strength of the target section can be further improved while the bending performance of the first target section of the support plate can be ensured to further improve the impact resistance capability of the support plate and improve the reliability of the display panel.

In some other embodiments of the present disclosure, h=a+b/2h, i.e., Ln=Lmin+(a+b/2)*n. Thus, the first sizes of the first target through-holes of the plurality of rows can increase uniformly in a direction away from the first target through-hole of the target row. Thus, the structural strengths at different positions of the support plate can change uniformly to further improve the structural strength of the target section by ensuring the bending performance of the first target section of the support plate. Then, the impact resistance capability of the support plate can be improved to improve the reliability of the display panel.

In some other embodiments of the present disclosure, h can be other numbers, which is not limited here.

In some embodiments, since the bending capability of the second target section is greater than the bending capability of the first target section, the second target section can at least correspond to the central area of the flexible section of the display screen. When the display screen is in a deformed state, the position of the second target section corresponding to the central area of the flexible section can have a high requirement for the bending performance. Thus, in some embodiments, the size of the through-hole in the second target section in the second direction can be greater than the size of the through-hole at another position of the target section in the second direction. Thus, the bending central area of the display panel can have a relatively good bending performance.

In some embodiments, the through-holes of the second target section can have the same size in the second direction to cause the positions of the second target section to have a relatively good bending performance. As shown in FIG. 5, the second target section 2012 includes a plurality of rows of sixth target through-holes 23 arranged in the first direction X. The sixth target through-holes 23 of each row can have the same size in the second direction Y. In some embodiments, the size of the through-hole of the second target section in the second direction can be the maximum value of the sizes of the through-holes of the target section in the second direction.

In some embodiments, as shown in FIG. 10, the first through-hole includes a first position. In the second direction, the distance between the first positions of two neighboring first through-holes can be the first distance D1. The first position can be the boundary of the first through-hole, the center of the first through-hole, or any other position of the first through-hole, which is not limited, as long as the first positions of the two neighboring first through-holes are the same position of the first through. If the first position of the first first through hole is the boundary of the first through, and the first position of the second first through-hole is also the boundary of the first through-hole, the first position of the first first through-hole can be the center of the first through-hole, and the first position of the second first through-hole can be the center of the first through-hole.

Similarly, as shown in FIG. 10, the second through-hole includes a second position. In the second direction, the distance between the second positions of the two neighboring second through-holes is a second distance D2. The second position of the second through-hole can be the boundary of the second through-hole, the center of the second through-hole, or another position of the second through-hole, as long as the second positions of the two neighboring second through-holes are the same position of the second through-hole.

In some embodiments, the first distance D1 can be equal to the second distance D2. Thus, the repetitive units of different rows of the target section can have the same size in the second direction. In the second direction, the repetitive unit can include the section where the through-hole is located and the distance section between the through-hole and another through-hole. For example, in the second direction, each row of through-holes can include a plurality of through-holes. The repetitive unit can include the section where the j-th through-hole and the section between the j-th through-hole and the (j+1)-th through-hole.

In some embodiments, the first through-hole and the second through-hole can belong to two neighboring rows of through-holes arranged in the first direction of the target section. As shown in FIG. 10, the first through-hole of the first section includes the j-th through-hole and the (j+1)-th through-hole in the second direction that are neighboring to each other. The second through-hole of the second section includes the k-th through-hole and the (k+1)-th through-hole that are neighboring to each other in the second direction. In some embodiments, in the first direction, the j-th through-hole and the k-th through-hole can partially overlap with each other. The center of the j-th through-hole can be the third position. The center of the gap between the k-th through-hole and the (k+1)-th through-hole can be the fourth position. In the first direction, the third position and the fourth position can be located on the same straight line to avoid excessive integration of the positions of the first through-hole and the second direction of the second through-hole to affect the structural strength of the positions of the target section where the first through-hole and the second through-hole are located in the second direction.

Similarly, in the first direction, the (k+1)-th through-hole can partially overlap with the j-th through-hole and the (j+1)-th through hole, and the center of the (k+1)-th through-hole can be a fifth position. The center of the gap between the j-th through-hole and the (j+1)-th through-hole can be a sixth position. In the first direction, the fifth position and the sixth position can be on the same straight line to avoid excessive integration of the positions of the first through-hole and the second through-hole in the second direction to affect the structural strength of the positions of the target section where the first through-hole and the second through-hole are located in the second direction.

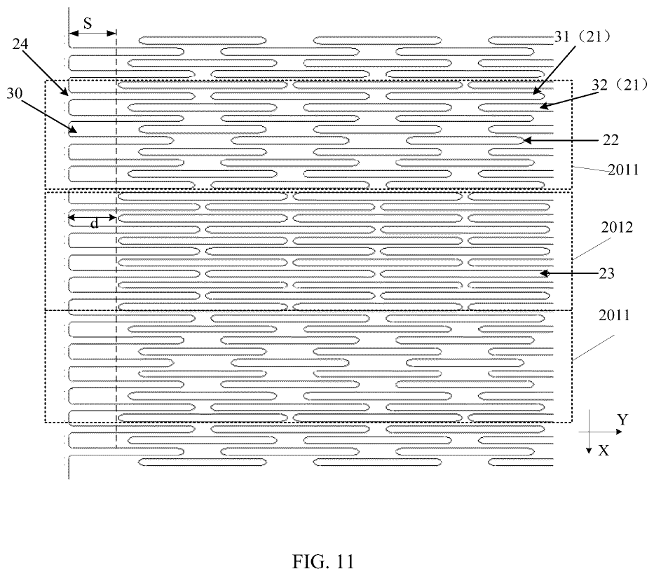

When the first through-hole and the second through-hole belong to the two neighboring rows of the target section, one of the first through-hole and the second through-hole can be in an odd number row, and the other one can be in an even number row. As shown in FIG. 11, if the first through-hole 31 is in the odd row of the target section, the second through-hole 32 is in the even number row of the target section arranged along the first direction. The first area can further include an opening 24 extending from the boundary of the support plate along the second direction into the inside of the support plate. The opening 24 can be in the same row as the first through-hole 31. In the second direction, the distance between opening 24 and the first through-hole 31, neighboring to opening 24, can be the first distance. Thus, the area where any one solid section of the support plate is located in the row where the first through-hole is can have the same size in the second direction. In the row of the first through-hole, the uniformity of the removal section of the support plate in the entire body (e.g., the removal section of the support plate includes a section where the through-hole is and a section where the opening is), formed by the first through-hole and the opening can be improved in the row where the first through-hole is, which is not limited.

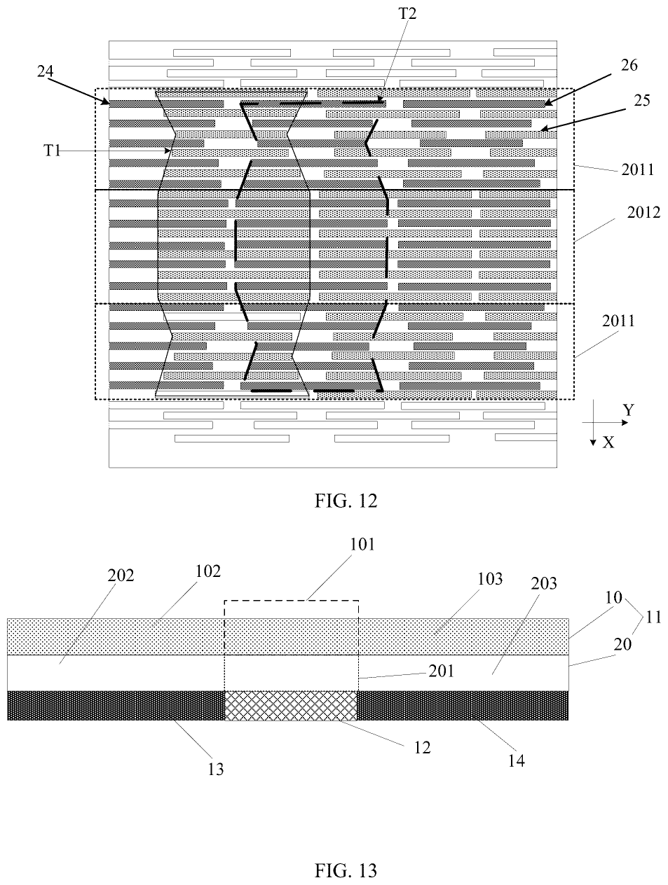

In some embodiments, as shown in FIG. 12, the target section includes a first unit group. The first unit group can include a plurality of second target through-holes 25 arranged along the first direction X. The first through-hole and the second through-hole can belong to the plurality of second target through-holes 25. The first unit group can represent the first image T1 by the plurality of second target through-holes 25. In some embodiments, the first image T1 can include a first hourglass shape arranged along the first direction X and located at the first target section and a first rectangle located at the second target section. In some embodiments, the first hourglass shape can be formed by an upright trapezoid and an inverted trapezoid.

In some other embodiments of the present disclosure, as shown in FIG. 12, the target section further includes a second unit group. The first unit group and the second unit group can be arranged at an interval based on the second direction. The second unit group includes a plurality of third target through-holes 26 arranged based on the first direction. The first through-hole and the second through-hole can belong to the plurality of third target through-holes 26. The second unit group can represent the second image T2 through the plurality of third target through-holes 26. In some embodiments, the second image T2 can include a second hourglass shape arranged along the first direction and located at the first target section and a second rectangle located at the second target section. In some embodiments, the second hourglass shape can be formed by an upright trapezoid and an inverted trapezoid.

In some embodiments, the second image and the first image can have the same shape, which is not limited.

In some embodiments of the present disclosure, the second target through-holes of the first unit group and the third target through-holes of the second unit group can be arranged in a staggered manner in the first direction. The overlapping area of the first image and the second image can form a third image. In some embodiments, the third image can include a third hourglass shape located at the first target section and a third rectangle located at the second target section and arranged along the first direction. The size of the third hourglass shape in the second direction can be smaller than the sizes of the first hourglass shape and the second hourglass shape in the second direction. The size of the third rectangle in the second direction can be smaller than the sizes of the first rectangle and the second rectangle in the second direction.

Accordingly, embodiments of the present disclosure also provide an electronic device. The electronic device includes the display panel above. In some embodiments, as shown in FIG. 13, the electronic device includes a display panel 11 and a connection apparatus 12. The display panel 11 includes the flexible display screen 10 and the support plate 20 located on the non-display output side of the display screen 10. The display screen 10 includes a flexible section 101. The support plate 20 includes a target section 201 corresponding to the flexible section 101 of the display screen 10. The connection apparatus 12 is arranged corresponding to the target section. The electronic device can perform device form change through the connection apparatus 12. The flexible section can deform with the target section.

In some embodiments, the target section can include a first area and a second area arranged along the first direction. The first area can include a first through-hole arranged in a second direction. The second area includes a second through-hole arranged in the second direction. The first through-hole and the second through-hole can have different sizes. The second direction is different from the first direction. By arranging the through-holes of different sizes in different areas of the support plate, the bending performance and structural strength of the support plate can be balanced. Thus, the display panel can well balance between the bending performance and reliability to further cause the electronic device to have a good balance between the bending performance and reliability.

In embodiments of the present disclosure, the size of the first through-hole in the second direction can be greater than the size of the first through-hole in the first direction. The size of the second through-hole in the second direction can be greater than the size of the second through-hole in the first direction. The size of the first through-hole in the second direction can be different from the size of the second through-hole in the second direction. The second direction can be parallel to the axis of the connection apparatus. By changing the sizes of the first through-hole and the second through-hole in the direction parallel to the axis of the connection apparatus, the bending performances and structural strengths of different positions in the target section can be adjusted.

In embodiments of the present disclosure, the electronic device can be a foldable electronic device. In some embodiments, the connection apparatus can include a hinge door panel. Height differences of various positions of the first predetermined area of the hinge door panel facing the support plate side in the first direction can be within a predetermined threshold range. As shown in FIG. 11, the first predetermined area of the hinge door panel corresponds to the second predetermined area S of the support plate. The second predetermined area S refers to the area of the support plate between the edge of the support plate and the fifth target through-hole of the target section. The fifth target through-hole can be the through-hole in the target section whose boundary is closest to the edge of the support plate. Thus, when the electronic device is dropped or impacted, and the hole wall of the fifth target through-hole of the support plate swings in the first direction, the hole wall may not collide with the hinge door panel, and the impact force received by the support plate can be enlarged, which affects the structural strength of the support plate to affect the reliability of the electronic device.

In some embodiments of the present disclosure, the first preset area may not include structural features such as screw holes or protrusions, and hinge components (e.g., hinge arms or gears). Thus, no size differences or gaps can be formed. However, it is not limited here.

In the second direction, when the width of the second predetermined area S is larger, when the electronic device is dropped, the swing amplitude of the second predetermined area S can be larger. The support plate can receive a larger impact force. Thus, the display screen can have a higher risk of being damaged subjected to the impact. Therefore, in some embodiments, as shown in FIG. 11, the size of the second predetermined area S in the second direction is d≤Lmax/3. Lmax is the maximum size of the through-holes of the target section in the second direction. Thus, the swing amplitude of the second predetermined area can be reduced when the electronic device is dropped, and the impact force received by the support plate due to the swing of the second predetermined area can be reduced when the electronic device is dropped. Then, the probability of damaging the display screen subjected to the impact can be reduced to improve the reliability of the electronic device.

As shown in FIG. 13, the electronic device includes a first body 13 and a second body 14. The connection apparatus 12 is configured to connect the first body 13 to the second body 14. The first section of the display panel 11 is assembled with the first body 13. The second section of the display panel 11 is assembled with the second body 14. In some embodiments, the display screen 11 includes a first screen section 102 corresponding to the first section and a second screen section 103 corresponding to the second section. The flexible section 101 is located between the first screen section 102 and the second screen section 103. The support plate 20 includes a first support board 202 corresponding to the first section and a second support board 203 corresponding to the second section. The target section 201 is located between the first support board 202 and the second support board 203 and corresponds to the flexible section. The first support board 202 is fixed to the first screen section 102, and the second support board 203 is fixed to the second screen section 103. The target section 201 matches the flexible section 101.

In some embodiments of the present disclosure, the first body 13 can be glued to the first support board, and the second body 14 can be glued to the second support board.

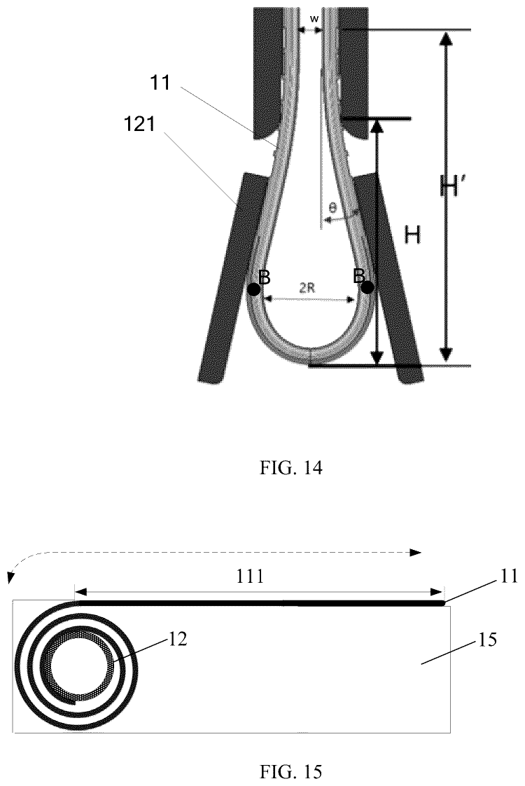

FIG. 14 illustrates a schematic local structural diagram of an electronic device in a bent state as a water droplet shape according to some embodiments of the present disclosure. In some embodiments, the position where the bent central axis of the target section is at an apex of the water droplet arc. The distance from the apex of the water droplet arc to the edge of the first body facing the connection apparatus side is H. The distance from the apex of the water droplet arc to the edge of the bonding area between the first body and the first support board is H′. The radius of the water droplet arc is R, the angle between the hinge door panel 121 and the plane where the first support board is located is Θ, and the gap between the first screen section and the second screen section is w. In embodiments of the present disclosure, H=10.58 mm, H′=15.05 mm, R=2.01 mm, w=0.99 mm, and Θ=12.2°, which is not limited.

The electronic device can be a multi-body system including the display panel, connection apparatus, and the housing (e.g., the body of the electronic device). The display panel can be also a multi-layer coupling body. Different composition layers can withstand different types and magnitudes of impacts according to the physical characteristics of the composition layers. The display panel can be connected to the connection apparatus through the support board at the bottom. Under the constraints and actuation of the connection apparatus and the body mechanism of the electronic device, different sections of the display panel can open and close in a specific trajectory.

When the electronic device experiences an external impact, such as a fall, the impact can be transmitted from the housing and connection apparatus to the first receptor of the display panel, i.e., the support board, and then to the display screen. In the multi-layer structure of the display screen, a specific layer, such as an organic encapsulation composition layer, can be the most fragile section of the display screen and be most prone to failure to cause the display screen to fail. The material characteristics of the specific layer can withstand a large compressive stress but a small tensile stress. The specific layer can be most susceptible to failure under alternating stresses.

In a specific trajectory, under the multi-layer coupling of the multi-body system and the coupling body, the organic encapsulation layer can withstand specific stresses and strains at different trajectory positions. An extreme point can exist, where the encapsulation layer can be most prone to failure, i.e., the high risk point. At the high risk point, by increasing the strength and rigidity of the support board, the impact withstanding ability of the support board can be improved to prevent the failure of the support board to cause the specific layer to fail. Meanwhile, the level of the impact transmitted to the inside of the display screen can be improved and reduced.

In embodiments of the present disclosure, when the display panel is in a folded state, i.e., when the display panel is in a water droplet shape, the high-risk point can be located at a certain distance from the connection section of the support board (i.e., the edge of the bonding area between the first body and the first screen section, which is the upper edge of H′ in FIG. 14), e.g., position B in FIG. 14, to form a certain cantilever space. When the external impact starts to propagate in the support board from the connection segment, the peaks/troughs can be prone to alternate at the high-risk point to generate a impact wave to be transmitted to the inside of the display screen to generate alternating stresses at the organic encapsulation layer to cause the organic encapsulation layer to fail.

Therefore, in some embodiments of the present disclosure, the first target through-hole of the target row in the target section can be located at position B with a certain distance from the connection segment of the support board. When the electronic device is dropped, the boundary area of compressive strains and tensile strains formed by the impact received by the encapsulation layer of the display screen is not limited.

In some embodiments of the present disclosure, as shown in FIG. 11, the target section further includes a plurality of tooths 30 arranged along the first direction. The area between neighboring tooths 30 can be the opening 24. In some embodiments of the present disclosure, the first target section can include 16 tooths and 10 rows of first target through-holes arranged along the first direction. The first target through-holes of the target row can be the first target through-holes of the sixth row. The area of the first target section away from the second target section can include 5 rows of first target through-holes, and the area of the first target section close to the second target section can also include 5 rows of first target through-holes. The second target section can include 11 rows of sixth target through-holes arranged in the first direction.

In some embodiments, the first target through-holes of the target row can have a size L=3.0 mm in the second direction, and the sixth target through-holes can have a size L=4.5 mm in the second direction. In the first target through-holes and the sixth target through-holes, 2a=2=0.2 mm. in the first direction, the distance between neighboring through-holes can be 0.12 mm. That is, in the first direction, the distance between the neighboring first target through-holes can be 0.12 mm, and the distance between the neighboring sixth target through-holes can be 0.12 mm. The size difference of the neighboring first target through-holes can be ΔL=0.3 mm in the second direction, i.e., h=0.3 mm and d=1.43 mm, which is not limited here.

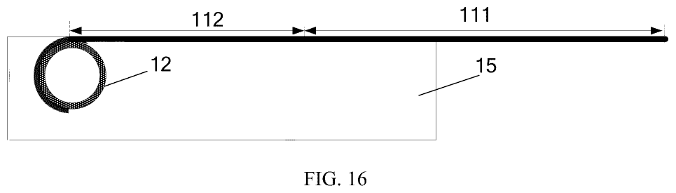

In some other embodiments of the present disclosure, the electronic device can be a scrollable electronic device. As shown in FIGS. 15 and 16, FIG. 15 illustrates a schematic local structural diagram of the electronic device in an accommodated state according to some embodiments of the present disclosure. FIG. 16 illustrates a schematic local structural diagram of the electronic device in a flat state according to some embodiments of the present disclosure. In some embodiments, the electronic device includes a device body 15. The device body 15 includes an accommodation space configured to accommodate at least a part of the connection apparatus and the flexible section. In some embodiments, the display panel can include a first section 111 and a second section 112. The display screen can include a third screen section corresponding to the first section 111 and a flexible section corresponding to the second section 112. The support plate can include a third support board and a target section. The third support board can be fixed to the third screen section. The target section can match the flexible section. In some embodiments, the second section can be assembled with the connection apparatus. The connection apparatus can drive the display panel to adjust the area of the second section in the device body along a dashed line arrow direction in FIG. 15 to adjust the display area of the electronic device.

When the flexible section of the display screen is in the completely accommodated state, the curvature radius of the section of the second section of the display panel closer to the connection apparatus can be smaller. Correspondingly, the bending capability of the section of the target section of the support plate corresponding to the section of the second section of the display panel closer to the connection apparatus can be stronger. In embodiments of the present disclosure, when the flexible section of the display screen is in the completely accommodated state, the size of the through-hole of the target section of the support plate closer to the connection apparatus can be larger in the second direction, which is not limited.

In summary, in the electronic device and display panel of embodiments of the present disclosure, the first through-holes and the second through-holes of the target section of the support plate corresponding to the flexible section of the display screen can have different sizes in the second direction. Thus, the through-holes with different sizes can be arranged in different areas in the support plate to balance the bending performance and the structural strength of the support plate to further improve the structural strength of the support structure by ensuring the bending performance of the support plate to increase the impact force that the support plate can withstand. Moreover, when the display panel drops, the impact received by the display screen can be reduced to reduce the probability of damaging the display screen. Thus, the display panel can well balance the bending performance and the reliability to improve the reliability of the electronic device.

Embodiments of the present disclosure further provide a preparation method for a support plate, which can be applied to the electronic device above. The electronic device can include a connection apparatus and a display panel. The display panel can include a flexible display screen and a support plate on the non-display output side of the display screen. The display screen can include the flexible section. The support plate can include the target section corresponding to the flexible section of the display screen. The connection apparatus can be arranged corresponding to the target section. The electronic device can perform device form change through the connection apparatus, with the flexible section and the target section deforming together. In some embodiments, the preparation method can include, based on the stress distribution in the display screen when the electronic device drops in the first manner under at least one form, determining the position and size of the through-hole of the target section of the support plate.

The support plate can include the target section corresponding to the flexible section of the display screen. The target section can include the first area and the second area arranged in the first direction.

The first area can include the first through-holes arranged along the second direction. The second area can include the second through-holes arranged along the second direction. The first through-holes and the second through-holes can have different sizes. The second direction can be different from the first direction.

In some embodiments of the present disclosure, the display panel can include an OLED display panel. The display screen can include an array substrate, a light-emitting layer on the surface of the array substrate, and an encapsulation layer that encapsulates the light-emitting layer. The array substrate can also include a plurality of composition layers. When the display panel is dropped, the stress distribution on different layers of the display screen may be different, and accordingly, the highest risk point can also be different.

In embodiments of the present disclosure, based on the stress distribution of the display screen when the electronic device is dropped in a first manner under at least one form, determining the positions and sizes of the through-holes in the target section of the support plate can include, based on the stress distribution of the display screen when the electronic device is dropped in a first manner under a plurality of forms, determining the positions and sizes of the through-holes in the target section of the support plate. Here, the first composition layer can be the encapsulation layer. That is, the encapsulation layer in the display screen can be used as an inspection object to obtain the stress distribution of the display screen, which is not limited here. In some other embodiments, the first composition layer can be any one composition layer in the display screen, which is determined as needed. By taking the first composition layer being the encapsulation layer as an example, the preparation method for the support plate of embodiments of the present disclosure is described.

In embodiments of the present disclosure, obtaining the stress distribution in the display screen when the electronic device is dropped in the first manner under at least one form can include obtaining the stress distribution on the first composition layer when the electronic device is dropped in the first manner under various forms. Accordingly, based on the stress distribution in the display screen when the electronic device is dropped in the first manner under the at least one form, determining the positions and sizes of the through-holes of the target section of the support plate can include, determining the highest risk point of the first composition layer based on the stress distribution on the first composition layer when the electronic device is dropped in the first manner under various forms, determining the size of the through-hole at the highest risk point of the first composition film corresponding to the support plate based on the highest risk point on the first composition layer, and determining the sizes of the through-holes at other positions of the target section based on the size of the through-hole of the target section of the support plate corresponding to the highest risk point on the first composition layer.

In some other embodiments of the present disclosure, the first manner can include that the electronic device is dropped on a display side and a non-display side. In some embodiments, determining the positions and sizes of the through-holes of the target section of the support plate based on the stress distribution in the first composition layer of the display screen when the display screen is in the deformed state can include determining the positions and sizes of the through-holes of the target section of the support plate based on the stress distribution on the first composition layer when the electronic device is in the flat state and the folded in half state and is dropped on the display side and the non-display side, which is not limited here.

In embodiments of the present disclosure, obtaining the stress distribution of the display screen when the electronic device is dropped in the first manner under at least one form can include obtaining the stress distribution on the first composition layer when the electronic device is dropped in the first manner under at least one form using a simulation experiment. For example, e.g., assisted by CAE simulation based on the form change trajectory of the electronic device, the stress distribution on the first composition layer can be obtained when the electronic device is dropped in the first manner under at least one form. In some other embodiments, obtaining the stress distribution in the display screen when the electronic device is dropped in the first manner under at least one form can include obtaining the stress distribution on the first composition layer when the electronic device is dropped in the first manner under at least one form by a sensor assembly arranged on the electronic device, which is not limited here.

In summary, embodiments of the present disclosure provide the preparation method for the support plate. The positions and sizes of the through-holes of the target section of the support plate can be determined based on the stress distribution of the display screen when the electronic device is dropped in the first manner under at least one form. Thus, by setting through-holes with different sizes at different areas in the support plate, the bending performance and the structural strength of the support plate can be balanced. Further, the structural strength of the support structure can be improved by ensuring the bending performance of the support plate, and the impact force that the support plate can withstand can be increased. When the display screen is subject to impact, the probability of damaging the display screen can be reduced to cause the display panel to well balance the bending performance and the reliability to improve the reliability of the electronic device.

Embodiments in the specification are described in a progressive manner, parallel manner, or a combination of the progressive manner and the parallel manner. Each embodiment focuses on the differences from other embodiments. The similar or identical parts between embodiments can refer to each other. Since the apparatus of embodiments of the present disclosure corresponds to the method of embodiments of the present disclosure, the description can be simple. For the related parts, reference can be made to the description of method embodiments.

The above description of embodiments of the present disclosure enables those skilled in the art to implement or use the present disclosure. Various modifications made to these embodiments are apparent to those skilled in the art. The general principle defined in the specification can be implemented in other embodiments without departing from the spirit or scope of the present disclosure. Thus, the present disclosure is not limited to these embodiments of the present disclosure but should conform to the broadest scope consistent with the principles and novel features of the present disclosure.

What is claimed is:

1. A display panel, comprising:
a flexible display screen, including a flexible section and switching between at least a flat state and a deformed state through the flexible section;
a support plate, located on a non-display output side of the display screen and including a target section corresponding to the flexible section of the display screen, the target section including a first area and a second area arranged along a first direction;
wherein:
the first area includes a first through-hole arranged along a second direction;
the second area includes a second through-hole arranged along the second direction;
the first through-hole and the second through-hole have different sizes; and
the second direction is different from the first direction.

2. The display panel of claim 1, wherein the first area and the second area are two neighboring areas in the target section.

3. The display panel of claim 2, wherein:
the target section includes a first target section and a second target section, a bending capability of the second target section is greater than a bending capability of the first target section;
the second target section at least corresponds to a central area of the flexible section of the display screen; and
at least one area of the first area and the second area is located at the first target section.

4. The display panel of claim 3, wherein:
the first area is located at the first target section;
the second area is located at the second target section; and
a size of the first through-hole in the second direction is smaller than a size of the second through-hole in the second direction.

5. The display panel of claim 3, wherein:
the first area and the second area are located in the first target section; and
the first area and the second area are any two neighboring areas in the first target section.

6. The display panel of claim 3, wherein:
the first target section includes a plurality of rows of first target through-holes arranged along the first direction, and the first through-hole and the second through-hole are first target through-holes of different rows of the plurality of rows of first target through-holes; and
in the plurality of first target through-holes, a size of a first target through-hole of a target row in the second direction is the smallest, and when a first target through-hole of a far end row have a farther distance from the first target through-hole of the target row in the first direction, a size of the first target through-hole of the far end row is larger.

7. The display panel of claim 2, wherein:
the first through-hole has a first position, and a distance between first positions of two neighboring first through-holes in the second direction is a first distance;
the second through-hole has a second position, and a distance between second positions of two neighboring second through-holes is a second distance;
the first distance equals the second distance.

8. The display panel of claim 2, wherein:
the first through-hole of the first area includes a j-th through-hole and a (j+1)-th through-hole neighboring to each other in the second direction, and the second through-hole of the second area includes a k-th through-hole and a (k+1)-th through-hole neighboring to each other in the second direction;
in the first direction, the j-th through-hole partially overlaps with the k-th through-hole and partially overlaps with the (k+1)-th through-hole, a center of the j-th through-hole is a third position, a center of a gap between the k-th through-hole and the (k+1)-th through-hole is a fourth position, and in the first direction, the third position and the fourth position are on a same straight line; and
in the first direction, the (k+1)-th through-hole partially overlaps with the j-th through-hole and partially overlaps with the (j+1)-th through-hole, and a center of the (k+1)-th through-hole is a fifth position, a center of a gap between the j-th through-hole and the (j+1)-th through-hole is a sixth position, and in the first direction, the fifth position and the sixth position are on the same straight line.

9. The display panel of claim 1, wherein the target section includes:
a first unit group including a plurality of second target through-holes arranged along the first direction;
the first through-hole and the second through-hole belong to the plurality of second target through-holes; and
the first unit group represents a first image through the plurality of second target through-holes.

10. The display panel of claim 9, wherein the target section further includes:
a second unit group, the first unit group and the second unit group being arranged in the second direction at an interval;
the second unit group includes a plurality of third target through-holes arranged along the first direction;
the first through-hole and the second through-hole belong to the plurality of third target through-holes; and
the second unit group represents a second image through the plurality of third target through-holes.

11. The display panel of claim 10, wherein:
the second target through-hole of the first unit group and the third target through-hole of the second unit group are arranged alternately in the first direction; and
an overlap area between the first image and the second image forms a third image.

12. An electronic device, comprising:
a display panel, including a flexible display screen and a support plate located on a non-display output side of the display screen, the display screen including a flexible section, and the support plate including a target section corresponding to a flexible section of the display screen; and
a connection apparatus corresponding to the target section, the electronic device performing device form change through the connection apparatus, the flexible section and the target section change form with;
wherein:
the target section includes a first area and a second area arranged in the first direction;
the first area includes a first through-hole arranged along the second direction, and the second area includes the second through-hole arranged along the second direction;
the first through-hole and the second through-hole have different sizes; and
the second direction is different from the first section.

13. The electronic device of claim 12, wherein:
a size of the first through-hole in the second direction is larger than a size of the first through-hole in the first direction;
a size of the second through-hole in the second direction is larger than a size of the second through-hole in the first direction;
a size of the first through-hole in the second direction is different from a size of the second through-hole in the second direction; and
the second direction is parallel to an axis of the connection apparatus.

14. The device of claim 12, wherein the first area and the second area are two neighboring areas in the target section.

15. The device panel of claim 14, wherein:
the target section includes a first target section and a second target section, a bending capability of the second target section is greater than a bending capability of the first target section;
the second target section at least corresponds to a central area of the flexible section of the display screen; and
at least one area of the first area and the second area is located at the first target section.

16. The device of claim 15, wherein:
the first area is located at the first target section;
the second area is located at the second target section; and
a size of the first through-hole in the second direction is smaller than a size of the second through-hole in the second direction.

17. The device of claim 15, wherein:
the first area and the second area are located in the first target section; and
the first area and the second area are any two neighboring areas in the first target section.

18. The device of claim 15, wherein:
the first target section includes a plurality of rows of first target through-holes arranged along the first direction, and the first through-hole and the second through-hole are first target through-holes of different rows of the plurality of rows of first target through-holes; and
in the plurality of first target through-holes, a size of a first target through-hole of a target row in the second direction is the smallest, and when a first target through-hole of a far end row have a farther distance from the first target through-hole of the target row in the first direction, a size of the first target through-hole of the far end row is larger.

19. The device of claim 14, wherein:
the first through-hole has a first position, and a distance between first positions of two neighboring first through-holes in the second direction is a first distance;
the second through-hole has a second position, and a distance between second positions of two neighboring second through-holes is a second distance;
the first distance equals the second distance.

20. The device of claim 14, wherein:
the first through-hole of the first area includes a j-th through-hole and a (j+1)-th through-hole neighboring to each other in the second direction, and the second through-hole of the second area includes a k-th through-hole and a (k+1)-th through-hole neighboring to each other in the second direction;
in the first direction, the j-th through-hole partially overlaps with the k-th through-hole and partially overlaps with the (k+1)-th through-hole, a center of the j-th through-hole is a third position, a center of a gap between the k-th through-hole and the (k+1)-th through-hole is a fourth position, and in the first direction, the third position and the fourth position are on a same straight line; and
in the first direction, the (k+1)-th through-hole partially overlaps with the j-th through-hole and partially overlaps with the (j+1)-th through-hole, and a center of the (k+1)-th through-hole is a fifth position, a center of a gap between the j-th through-hole and the (j+1)-th through-hole is a sixth position, and in the first direction, the fifth position and the sixth position are on the same straight line.
